(19) United States
(12) Patent Application Publication
(10) Pub. No.: US 2025/0373811 A1
(43) Pub. Date: Dec. 4, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 19/301,873

(22) Filed: Aug. 15, 2025

Related U.S. Application Data
(63) Continuation of application No. PCT/CN2024/076965, filed on Feb. 8, 2024.

(30) Foreign Application Priority Data
Feb. 16, 2023 (WO) PCT/CN2023/076538
Apr. 10, 2023 (WO) PCT/CN2023/087410

(51) Int. Cl. H04N 19/14; H04N 19/105; H04N 19/176

(52) U.S. Cl. CPC H04N 19/14; H04N 19/105; H04N 19/176

(57) ABSTRACT

Embodiments of the present disclosure provide a solution for video processing. A method for video processing is proposed. In the method, for a conversion between a current video unit of a video and a bitstream of the video, at least one reference sample used by a cross-component prediction (CCP) for the current video block is determined based on at least one of: a position of the current video block, a shape of the current video block, a size of the current video block, a position of a current coding tree unit (CTU), a shape of the current CTU or a size of the current CTU. The CCP of the current video block is determined based on the at least one reference sample. The conversion is performed based on the CCP.

### CROSS REFERENCE TO RELATED APPLICATIONS

This application is a continuation of International Application No. PCT/CN2024/076965, filed on Feb. 8, 2024, which claims the benefit of International Application No. PCT/CN2023/076538 filed on Feb. 16, 2023 and International Application No. PCT/CN2023/087410 filed on Apr. 10, 2023. The entire contents of these applications are hereby incorporated by reference in their entireties.

### FIELDS

Embodiments of the present disclosure relates generally to video processing techniques, and more particularly, to cross-component prediction (CCP).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. In the method, for a conversion between a current video unit of a video and a bitstream of the video, at least one reference sample used by a cross-component prediction (CCP) for the current video block is determined based on at least one of: a position of the current video block, a shape of the current video block, a size of the current video block, a position of a current coding tree unit (CTU), a shape of the current CTU or a size of the current CTU. The CCP of the current video block is determined based on the at least one reference sample. The conversion is performed based on the CCP. In this way, the selection of the reference samples can depend on position and/or shape/size of the current block and/or the current CTU.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining at least one reference sample used by a cross-component prediction (CCP) for a current video block of the video based on at least one of: a position of the current video block, a shape of the current video block, a size of the current video block, a position of a current coding tree unit (CTU), a shape of the current CTU or a size of the current CTU; determining the CCP of the current video block based on the at least one reference sample; and generating the bitstream based on the CCP.

In a fifth aspect, a method for storing a bitstream of a video is proposed. The method comprises: determining at least one reference sample used by a cross-component prediction (CCP) for a current video block of the video based on at least one of: a position of the current video block, a shape of the current video block, a size of the current video block, a position of a current coding tree unit (CTU), a shape of the current CTU or a size of the current CTU; determining the CCP of the current video block based on the at least one reference sample; generating the bitstream based on the CCP; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A illustrates an illustration of the effect of the slope adjustment parameter “u” for a model created with the current CCLM;

FIG. 4B illustrates an illustration of the effect of the slope adjustment parameter “u” for a model updated as proposed;

FIG. 5 illustrates neighboring blocks (L, A, BL, AR, AL) used in the derivation of a general MPM list;

FIG. 6 illustrates neighboring reconstructed samples used for DIMD chroma mode;

FIG. 7 illustrates intra template matching search area used;

FIG. 8 illustrates the use of IntraTMP block vector for IBC block;

FIG. 9 illustrates the division method for angular modes;

FIG. 10 illustrates extended MRL candidate list;

FIG. 11 illustrates an illustration of the template area;

FIG. 12 illustrates spatial part of the convolutional filter;

FIG. 13 illustrates reference area (with its paddings) used to derive the filter coefficients;

FIG. 14 illustrates four Sobel based gradient patterns for GLM;

FIG. 15 illustrates spatial GPM candidates;

FIG. 16 illustrates an GPM template;

FIG. 17 illustrates an GPM blending;

FIG. 18 illustrates a flowchart of a method for video processing in accordance with embodiments of the present disclosure; and

FIG. 19 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

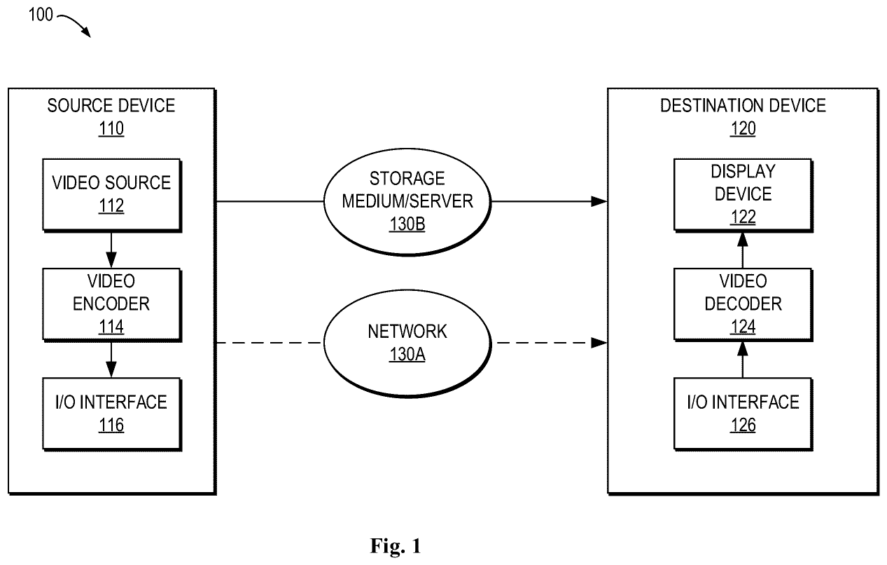

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

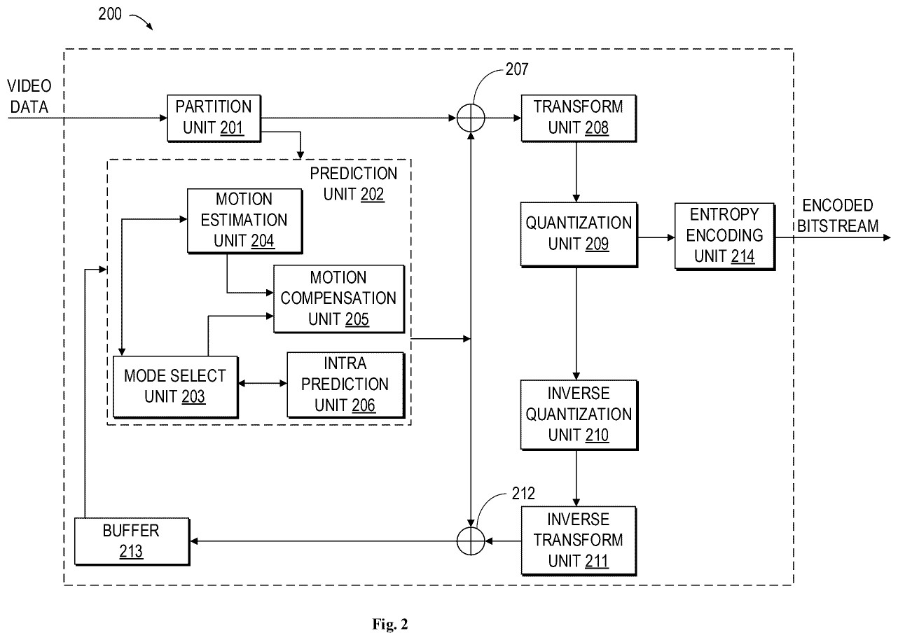

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the other video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

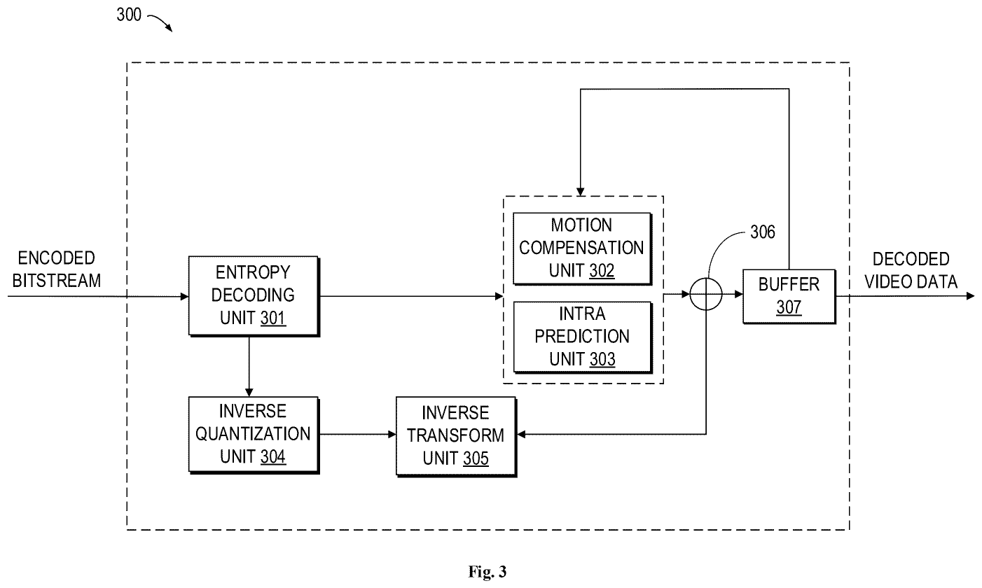

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about intra prediction in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chromaVal = a * lumaVal + b .$$

An adjustment “u” to the slope parameter is signaled to update the model to the following form:

$$chromaVal = a ’ * lumaVal + b ’$$

$$where$$

$$a ’ = a + u , b ’ = b - u * {y}_{r} .$$

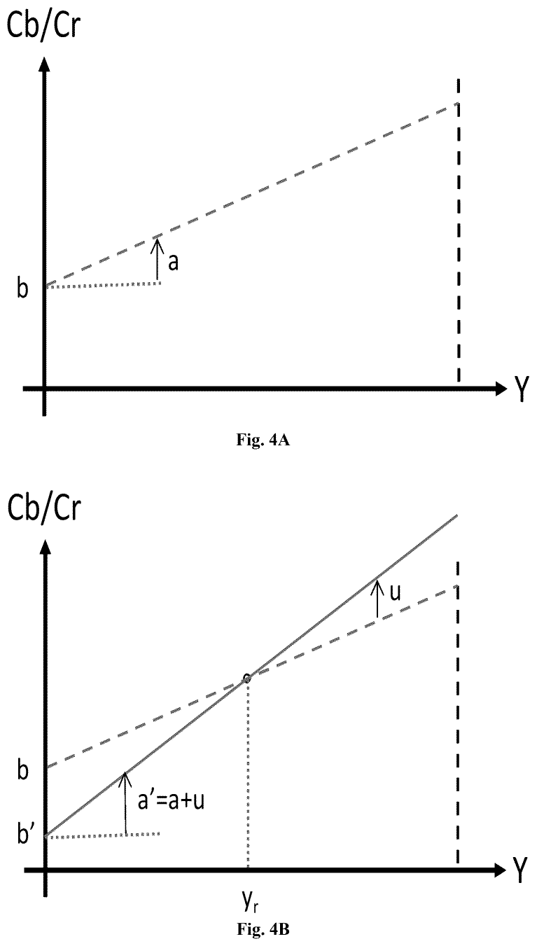

With this selection the mapping function is tilted or rotated around the point with luminance value yr. The average of the reference luma samples used in the model creation as yr in order to provide a meaningful modification to the model. FIG. 4A and FIG. 4B illustrate the process.

FIG. 4A illustrates the effect of the slope adjustment parameter “u” for a model created with the current CCLM.

FIG. 4B illustrates the effect of the slope adjustment parameter “u” for a model updated as proposed.

### Implementation

Slope adjustment parameter is provided as an integer between-4 and 4, inclusive, and signaled in the bitstream. The unit of the slope adjustment parameter is ⅛th of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

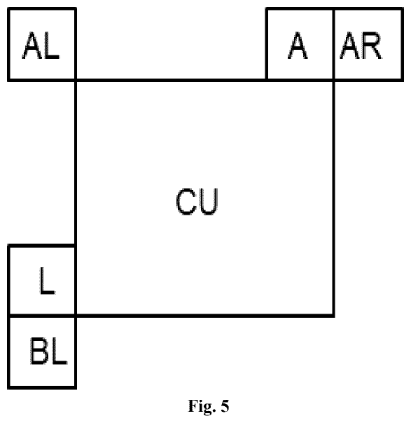

FIG. 5 shows neighbouring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log2 ( G x ) )$$

$$normDiff = ( ( Gx << 4 ) >> x ) \& 15$$

$$x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

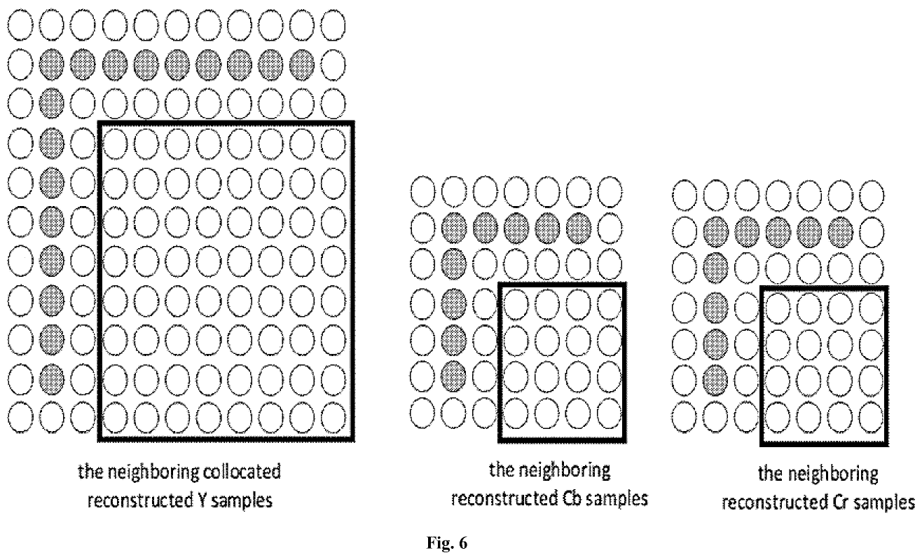

FIG. 6 shows neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * p r e d 0 + w 1 * p r e d 1 + ( 1 << ( shift - 1 ) ) ) >> shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. This method only applies to I slices.

### 2.1.7 Intra Template Matching

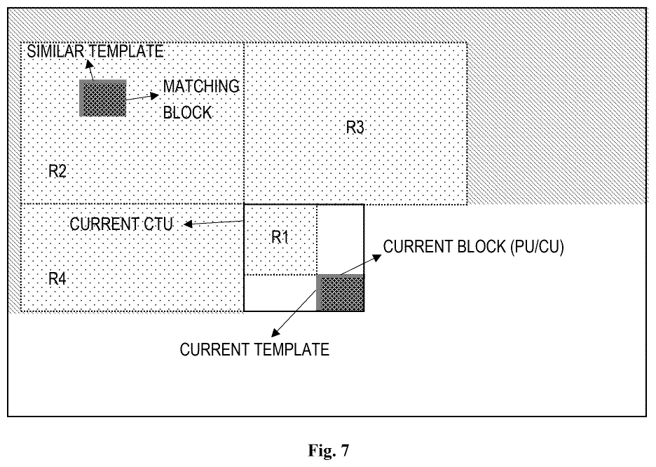

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped causal neighbor of the current block with another block in a predefined search area in FIG. 7 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

Where ‘a’ is a constant that controls the gain/complexity trade-off. In practice, ‘a’ is equal to 5.

FIG. 7 shows intra template matching search area used.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

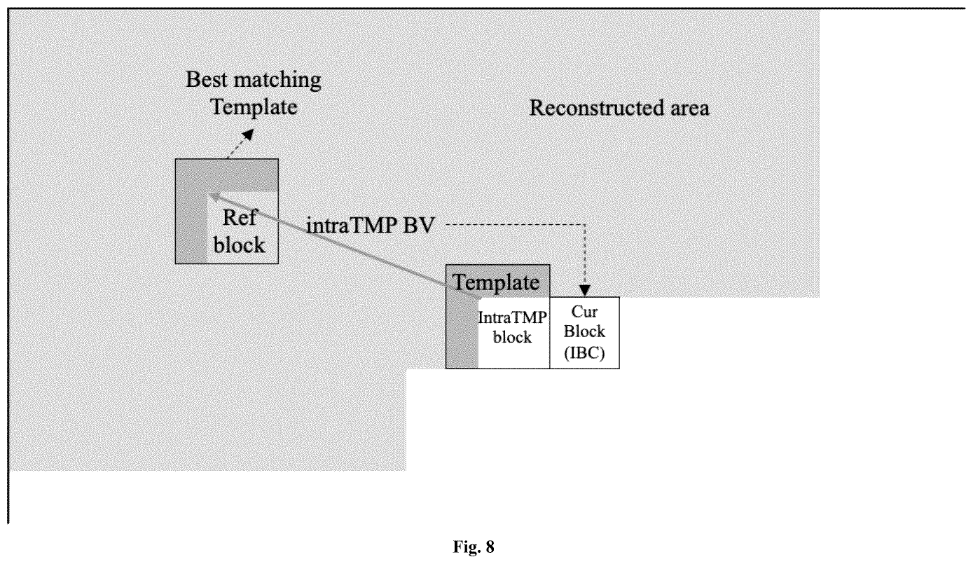

IntraTMP block vector is stored in the IBC block vector buffer and, the current IBC block can use both IBC BV and IntraTMP BV of neighbouring blocks as BV candidate for IBC BV candidate list as shown in FIG. 8.

FIG. 8 shows the use of IntraTMP block vector for IBC block.

IntraTMP block vectors are added to IBC block vector candidate list as spatial candidates.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costModel .$$

If this condition is true, the fusion is applied, otherwise the only model is used.

Weights of the modes are computed from their SATD costs as follows:

$$\begin{matrix}weight 1 = costMod e 2 / ( costModel + costMode 2 ) , \\ weight 2 = 1 - weight 1.\end{matrix}$$

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as pfusion=Wopline+W1Pline+1, where pline is the intra prediction from the default reference line and pline+1 is the prediction from the line above the default reference line. The weights are set as W₀=3/4 and w1=1/4.
For TIMD mode with blending, Pline is used for the first mode (W₀=1, W1=0) and pline+1 is used for the second mode (W₀=0, w1=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index <34), the current block is vertically divided; for near-vertical modes (34<=angular mode index <=66), the current block is horizontally divided.

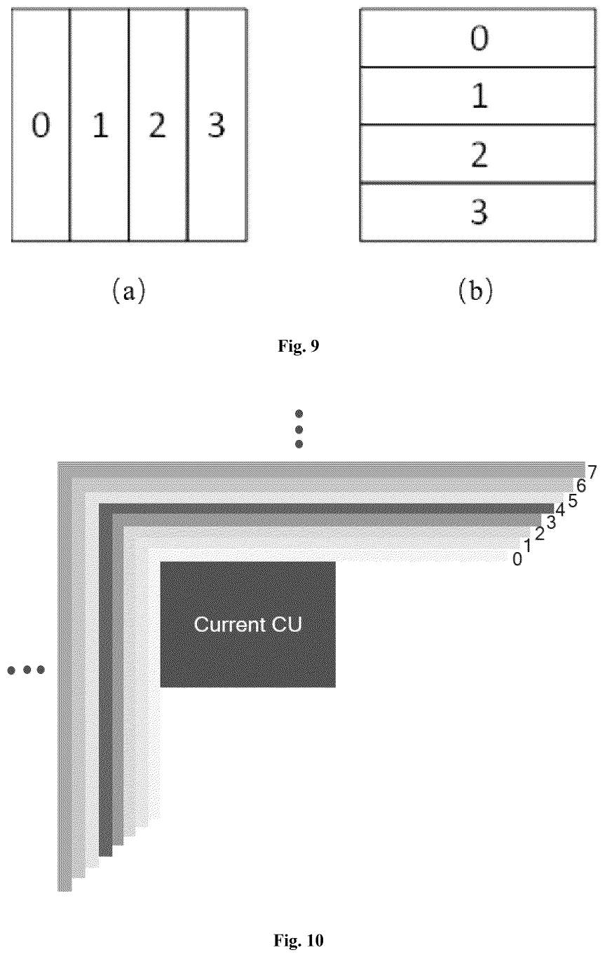

The (wIntra, wInter) for different sub-blocks are shown in FIG. 9. FIG. 9 shows the division method for angular modes.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CHIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used.

FIG. 10 shows extended MRL candidate list.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode. The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs’ modes and DIMD modes if its not included and the angular modes with delta angles from +1 to +4 (compared the existing angular modes in the intra-prediction-mode candidate list) are added.

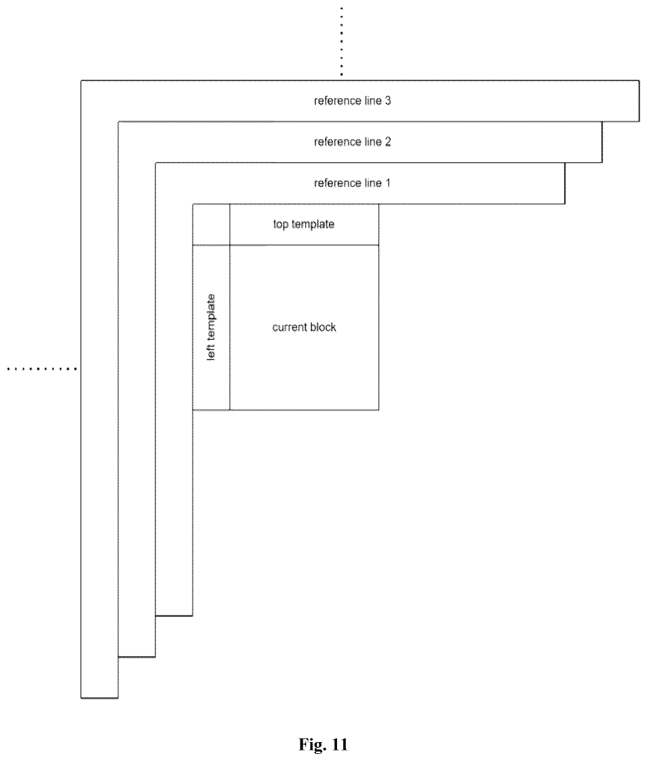

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list.

FIG. 11 shows the template area.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated below.

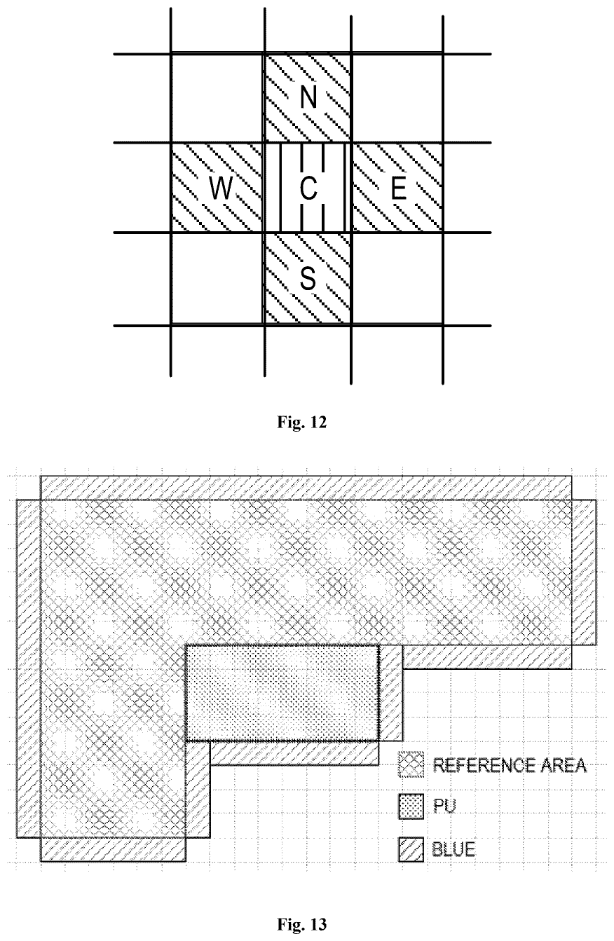

FIG. 12 shows a spatial part of the convolutional filter.

The nonlinear term P is represented as power of two of the center luma sample C and scaled to the sample value range of the content:

$$P = ( C * C + midVal ) >> \text{bitDepth.}$$

That is, for 10-bit content it is calculated as:

$$P = ( C * C + 5 \; 12 ) >> 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.1.13.2 Calculation of Filter Coefficients

The filter coefficients ci are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

FIG. 13 shows the reference area (with its paddings) used to derive the filter coefficients.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}{C}^{′} = C - offsetLuma , \\ {N}^{′} = N - offsetLuma , \\ {S}^{′} = S - offsetLuma , \\ {E}^{′} = E - offsetLuma , \\ {W}^{′} = W - offsetLuma , \\ {P}^{′} = nonLinear ( {C}^{′} ) , \\ B = midValue = 1 << ( bitDepth - 1 ) ,\end{matrix}$$

and the chroma value is predicted using the following equation, where offsetChroma is equal to offsetCr and offsetCb for Cr and Cb components, respectively:

$$predChromaVal = {coC}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β .$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β .$$

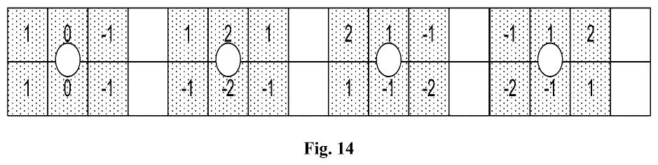

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14. FIG. 14 shows four Sobel based gradient patterns for GLM.

### 2.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

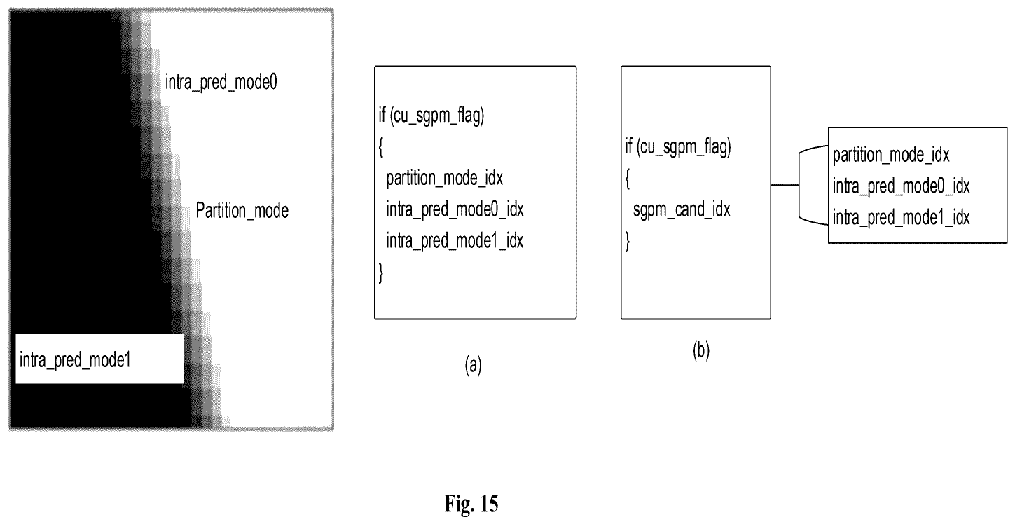

SGPM is an intra mode that resembles the inter coding tool of GPM, where the two prediction parts are generated from intra predicted process. In this mode, a candidate list is built with each entry containing one partition split and two intra prediction modes as shown in FIG. 15. FIG. 15 shows the spatial GPM candidates. 26 partition modes and 3 of intra prediction modes are used to form the combinations, the length of the candidate list is set equal to 16. The selected candidate index is signalled.

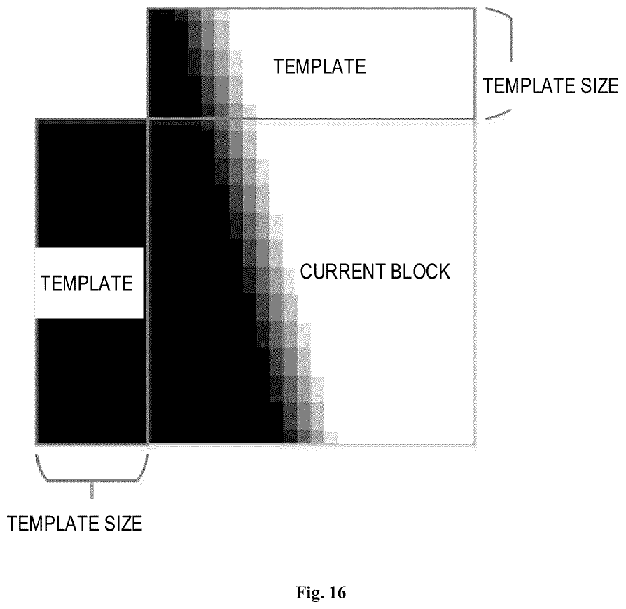

The list is reordered using template (FIG. 16) where SAD between the prediction and reconstruction of the template is used for ordering. The template size is fixed to 1.

FIG. 16 shows GPM template.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width <=64, 4<=height <=64, width<height*8, height<width*8, width*height>=32.

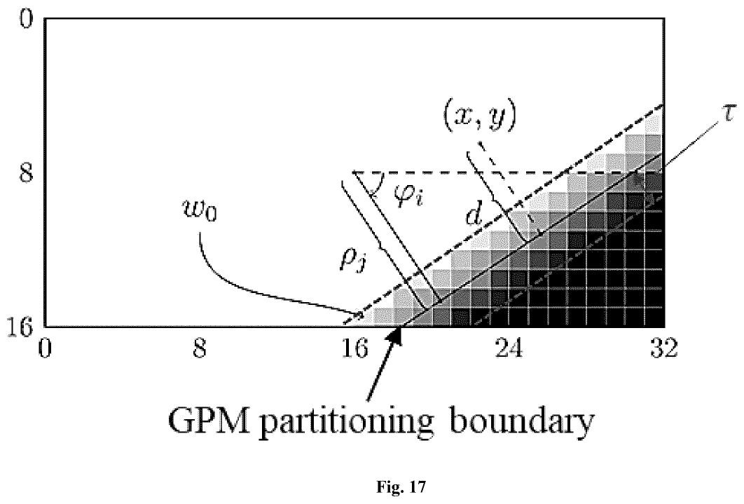

Adaptive blending is also used for spatial GPM, where blending depth t shown in FIG. 17 is derived as follows:
If min (width, height)==4, 1/2 t is selected,
else if min (width, height)==8, t is selected,
else if min (width, height)==16, 2 t is selected,
else if min (width, height)==32, 4 t is selected,
else, 8 τ is selected.

FIG. 17 shows the GPM blending.

### 3. Problems

There are several issues in the existing video coding techniques, which would be further improved for higher coding gain.
1. In ECM (e.g., up to ECM-8.0), GLM mode is supported only for single model LM, and it predicts chroma prediction value from both luma gradient and luma reconstruction value. However, multiple models may be allowed for GLM mode for higher coding efficiency.
2. In ECM (e.g., up to ECM-8.0), GLM always uses same reference lines as CCCM (e.g., 6 lines of down-sampled luma reference) for model calculation, which may be improved.
3. In ECM (e.g., up to ECM-8.0), up to one row of samples above the CTU top boundary could be used for CCLM/MMLM mode coding, but however, there is no such restriction for GLM/CCCM modes, which may be aligned.

### 4. Detailed Solutions

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

The term “LM” may refer to any linear regression-based method, such as CCLM, MMLM, CCCM, GL-CCCM, CCCM without downsampling, GLM, GLM with luma value, etc.

The term “CCLM” may refer to a single model LM mode, it could be single model CCLM, single model CCCM, single model GL-CCCM, single model CCCM without downsampling, single model GLM, single model GLM with luma value, etc.

The term “MMLM” may refer to a multi-model LM mode, it could be multi-model CCLM, MMLM, multi-model CCCM, multi-model GL-CCCM, multi-model CCCM without downsampling, multi-model GLM, multi-model GLM with luma value, etc.

The term “CCLM_TL” may refer to a single model LM mode which takes use of both left and above neighboring samples.

The term “MMLM_TL” may refer to a multi-model LM mode which takes use of both left and above neighboring samples.

The term “CCLM_L” may refer to a single model LM mode which takes use of only left neighboring samples. The term “MMLM_L” may refer to a multi-model LM mode which takes use of only left neighboring samples. The term “CCLM_T” may refer to a single model LM mode which takes use of only above neighboring samples. The term “MMLM_T” may refer to a multi-model LM mode which takes use of only above neighboring samples. The term “CCCM” may refer to a regular CCCM mode, or a GL-CCCM mode, or a CCCM without downsampling.

The term “GL-CCCM” may refer to a CCCM mode which considers gradients and locations of involved samples. The term “CCCM w/o downsampling” may refer to a CCCM mode which considers non-downsampled luma samples.

In the document, cross-component prediction (CCP) may refer to any cross-component prediction method such as any kind of CCLM/CCCM/GLM/GL-CCCM.

It is noted that the terminologies mentioned below are not limited to the specific ones defined in existing standards. Any variance of the coding tool is also applicable.

4.1 About multi-model GLM mode and related issues (e.g., the first problem), the following methods are proposed:
a. More than one GLM model may be built for a video unit (e.g., a GLM mode coded chroma block).
   a. For example, how to separate luma/chroma samples for different GLM models for the video unit may be dependent on neighboring samples.
      i. For example, luma samples neighboring to the video unit.
      ii. For example, furthermore, additionally, neighboring reconstruction samples.
      iii. For example, furthermore, alternatively, neighboring prediction samples.
      iv. For example, furthermore, additionally, neighboring down-sampled luma samples.
      v. For example, furthermore, alternatively, neighboring non-down-sampled luma samples.
      vi. For example, it may be based on the average/mid/middle value of a group of neighboring samples.
   b. For example, how to separate luma/chroma samples for different GLM models for the video unit may be dependent on luma samples in the collocated luma block.
      i. For example, collocated luma samples of the video unit.
      ii. For example, furthermore, additionally, collocated reconstruction samples.
      iii. For example, furthermore, alternatively, collocated prediction samples.
      iv. For example, furthermore, additionally, collocated down-sampled luma samples.
      v. For example, furthermore, alternatively, collocated non-down-sampled luma samples.
      vi. For example, it may be based on the average/mid/middle value of a group of collocated samples.
   c. In one example, how to separate/classify luma/chroma samples for different GLM models may depend on cost-comparison.
      i. For example, a first classification method may be applied to chroma samples neighbouring to the current block to obtain a first prediction on the neighbouring samples.
      ii. A distortion (such as SAD) between the reconstructed neighbouring samples and predicted neighbouring samples is derived as the cost for the first classification method.
      iii. The classification method with a minimum cost may be determined to be the selected classification method.
   d. For example, for each of the N GLM model (e.g., N>1 such as N=2), the model coefficients/parameters may be derived based on gaussian elimination equation.
b. For example, MMLM_TL, MMLM_T, MMLM_L modes may be supported for multi-model GLM coded video unit.
   a. For example, which mode is used may be explicitly signalled in the bitstream.
   b. For example, which mode is used may be implicitly derived by neighboring information (e.g., template cost).
   c. For example, GLM enabled/used flag may be signalled as true for MMLM_TL, MMLM_T, MMLM_L modes.
c. For example, only MMLM_TL mode may be supported for multi-model GLM coded video unit.
   a. For example, MMLM_T which uses above template only may not be allowed for multi-model GLM coded video unit.
   b. For example, MMLM_L which uses left template only may not be allowed for multi-model GLM coded video unit.
   c. For example, GLM enabled/used flag may be signalled as true for MMLM_TL mode.
d. Whether and/or how to apply multi-model GLM mode may be dependent on coding information (e.g., block width and/or height).
e. Whether and/or how to apply multi-model GLM mode may be dependent on VPDU.
f. Whether and/or how to apply multi-model GLM mode may be dependent on dual tree and/or local dual tree.
g. Whether and/or how to apply multi-model GLM mode may be dependent on color/chroma format (such as 4:4:4, 4:2:0, etc.).
h. For example, if the proposed method is applied to a GLM mode, at least one of the following conditions may be satisfied.
   a. The GLM mode considers both gradient and downsampled luma value for model calculation.
   b. The GLM mode considers non-downsampled luma value for model calculation.
   c. The model parameters of the GLM mode may be derived from a gaussian elimination solver (or an LDL based solver).
i. In one example, how to apply different GLM models (such as with different down-sampled or non-down-sampled luma value) may depend on cost-comparison.
   a. For example, a first GLM method may be applied to chroma samples neighbouring to the current block to obtain a first prediction on the neighbouring samples.
   b. A distortion (such as SAD) between the reconstructed neighbouring samples and predicted neighbouring samples is derived as the cost for the first GLM method.
   c. The GLM method with a minimum cost may be determined to be the selected GLM method.

4.2 About reference line of GLM mode and related issues (e.g., the second problem), the following methods are proposed:
a. The number of reference lines used for GLM mode coded video unit may be decoupled with that used for CCCM mode.
   a. For example, the number of reference lines used for GLM mode coded video unit may be different from (e.g., greater than, or less than) that used for CCCM mode.
   b. For example, the reference line may refer to reference row of samples above the video unit and/or reference column of samples left to the video unit.
b. For a certain GLM coded video unit, either M1 (e.g., M1=6) or M2 (e.g., M2=2) lines of reference may be used.
   a. For example, whether to use M1 or M2 reference lines may be implicitly derived based on coding information (e.g., based on template cost).
   b. For example, whether to use M1 or M2 reference lines may be explicitly signalled in the bitstream.
   c. For example, the reference line may refer to reference row of samples above the video unit and/or reference column of samples left to the video unit.
c. For example, at most K rows of samples above the CTU may be accessed if the reference line exceeds the CTU top boundary.
   a. For example, K=1.
   b. For example, the number of reference lines is restricted to not exceed the K-th row above the CTU top boundary.
   c. For example, if there is one reference line exceeds the K-th row of samples above the CTU top boundary, then GLM mode may not be allowed/used/enabled to the video unit.
   d. For example, if a reference line exceeds the K-th row of samples above the CTU top boundary, then such reference line may not be used to calculate the GLM model, but the GLM mode may be still allowed/used/enabled to the video unit (e.g., use only K rows of reference samples).
d. For example, at most L columns of samples left the CTU may be accessed if the reference line exceeds the CTU left boundary.
   a. For example, L=1.
   b. For example, the number of reference lines is restricted to not exceed the L-th column of samples left the CTU left boundary.
   c. For example, if there is one reference line exceeds the L-th column of samples left the CTU left boundary, then GLM mode may not be allowed/used/enabled/applied to the video unit.
   d. For example, if a reference line exceeds the L-th column of samples left the CTU left boundary, then such reference line may not be used to calculate the GLM model, but the GLM mode may be still allowed/used/enabled/applied to the video unit (e.g., use only L columns of reference samples).
e. Alternatively, there may be no restriction on the reference line usage for GLM mode, even if the reference line could reach far away from the CTU top boundary.
f. In one example, reference lines of GLM model may depend on cost-comparison.
   a. For example, a first set of reference lines of GLM method may be applied to chroma samples neighbouring to the current block to obtain a first prediction on the neighbouring samples.
   b. A distortion (such as SAD) between the reconstructed neighbouring samples and predicted neighbouring samples is derived as the cost for the first set of reference lines.
   c. The reference lines with a minimum cost may be determined to be the selected GLM method.

4.3 About the CTU boundary restriction and related issues (e.g., the third problem), the following methods are proposed:
a. In one example, the selection of reference samples (comprising luma samples and/or chroma samples) used by cross-component prediction (CCP) may depend on the position and/or shape/size of the current block and/or the current CTU.
   a. In one example, the selection of reference samples may depend on whether the current block is on the boundary of a CTU.
   b. In one example, the selection of reference samples may depend on whether the current block is on the boundary of a CTU-row.
b. In one example, whether a reference sample (comprising luma samples and/or chroma samples) used by cross-component prediction (CCP) is in a valid region or out of a valid region may depend on the position of a reference sample.
   a. For example, the reference sample at (x, y) may be treated as out of a valid region if y<=(Y0-M), wherein (X0, Y0) is the top-left position of the current CTU and M is an integer.
c. The restriction of how many rows of reconstruction/prediction samples above the CTU (or, VPDU) top boundary are allowed to be accessed, may be aligned for intra mode coding.
   a. For example, the number of rows of samples above the CTU (or, VPDU) top boundary may be restricted to a same value for at least two of the following intra modes.
      i. CCLM/MMLM.
      ii. CCCM and/or its variant (e.g., GL-CCCM, CCCM without downsampling).
      iii. GLM and/or its variant (e.g., GLM with luma).
      iv. TMRL and/or its variant.
      v. MRL and/or its variant.
      vi. Intra chroma fusion and/or its variant (e.g., chroma fusion with luma).
      vii. DIMD and/or its variant.
      viii. TIMD and/or its variant.
      ix. Intra template matching and/or its variant.
      x. SGPM and/or its variant.
      xi. DBV chroma and/or its variant.
   b. For example, a template of an intra mode may contain at least one sample above the first row of the CTU top boundary.
      i. For example, the template may be used for a template based intra mode coding.
      ii. For example, the template based intra mode may be one of the following modes:
         1. template based multiple reference line selection (e.g., TMRL, extended MRL list, etc.).
         2. a CCP mode (e.g., CCLM, CCCM, GLM, CCCM w/o downsampling, GL-CCCM, history based CCP mode, non-adjacent based CCP mode, non-local CCP mode, cross-component merge (CCMerge) mode, etc.).
         3. DIMD mode (DIMD luma, DIMD chroma, location dependent DIMD, etc.).
         4. TIMD mode.
         5. Template cost based intra chroma fusion.
         6. intraTMP and related mode.
         7. Derived block vector mode (e.g., DBV).
d. The restriction of how many rows of reconstruction/prediction samples above the CTU (or, VPDU) top boundary are allowed to be accessed, may be aligned for inter mode coding.
   a. For example, the number of rows of samples above the CTU (or, VPDU) top boundary may be restricted to a same value for at least two of the following inter modes.
      i. Inter template matching based methods (e.g., TM merge, GPM TM, CIIP TM, subTMVP TM, BCW TM, affine TM, MMVD TM, TM refinements, etc.).
      ii. Inter template cost based methods (e.g., ARMC, block based reference picture reordering, GPM split mode reordering, MVD sign prediction, merge list reordering, etc.).
      iii. GPM inter-intra and/or its variant.
      iv. OBMC and/or its variant.
      v. LIC and/or its variant.
      vi. MHP and/or its variant.
   b. For example, a template of an inter mode may contain at least one sample above the first row of the CTU top boundary.
      i. For example, the template may be used for a template based inter mode coding.
      ii. For example, the template based inter mode may be one of the following modes:
         1. TM merge.
         2. TM AMVP.
         3. Template based MMVD.
         4. Template based CIIP prediction.
         5. Template based GPM prediction.
         6. Template based Affine prediction.
         7. Template based SbTMVP prediction.
         8. Template based AMVP prediction.
         9. Template based reference picture reordering.
         10. Template based MVD sign prediction.
         11. Template based MVD coefficient prediction.
e. The restriction of how many rows of reconstruction/prediction samples above the CTU (or, VPDU) top boundary are allowed to be accessed, may be aligned for SCC mode coding.
   a. For example, the number of rows of samples above the CTU (or, VPDU) top boundary may be restricted to a same value for at least two of the following SCC modes.
      i. Regular IBC.
      ii. RR-IBC.
      iii. BVD sign prediction.
      iv. Template matching based BV refinements.
      v. Template cost-based BV candidate reordering.
      vi. DBV chroma and/or its variant.
      vii. Intra template matching and/or its variant.
   b. For example, a template of a SCC mode may contain at least one sample above the first row of the CTU top boundary.
      i. For example, the template may be used for a template based SCC mode coding.
      ii. For example, the template based SCC mode may be one of the following modes:
         1. intraTMP and related modes.
         2. Derived block vector mode (e.g., DBV).
         3. Template based IBC/RR-IBC prediction.
         4. Template based BVD sign prediction.
         5. Template based MBVD.
f. The restriction of how many rows of reconstruction/prediction samples above the CTU (or, VPDU) top boundary are allowed to be accessed, may be aligned for intra mode coding and inter mode coding and SCC mode coding.
g. For example, for a certain prediction mode, it is restricted to not exceed K rows of samples above the CTU top boundary.
   a. For example, K=1 or 6 or 12 for chroma samples.
   b. For example, K=1 or 6 or 12 for non-downsampled luma samples.
   c. For example, K=1 or 6 or 12 for downsampled luma samples.
   d. For example, if there is one reference line exceeds the K-th row of samples above the CTU top boundary, then the prediction mode may not be allowed/used/enabled/applied to the video unit.
   e. Alternatively, if a reference line exceeds the K-th row of samples above the CTU top boundary, then such reference line may not be used for the video unit, but the prediction mode may be still allowed/used/enabled/applied to the video unit (e.g., use only K rows of reference samples).
   f. For example, different values of K may be used for different modes.
   g. For example, at least two prediction modes have a same restriction on the value of K.
h. In one example, the reference samples out of the valid region may be padded.
i. In one example, the reference samples out of the valid region may not be involved to derive the CCP model.
j. In one example, for luma value based intra chroma fusion, at most M rows and/or N columns of neighboring samples may be used as training samples to modulate the intra chroma fusion model.
   a. For example, at most M (e.g., M=6) rows and/or N (e.g., N=6) columns of neighboring chroma samples and/or downsampled luma samples may be used.
   b. For example, at most 2*M (e.g., M=6) rows and/or 2*N (e.g., N=6) columns of neighboring non-downsampled luma samples may be used.
   c. For example, the intra chroma fusion may refer to a mode which fuses a nonLM chroma prediction with a collocated downsampled luma reconstruction.
   d. For example, the intra chroma fusion may be based on a linear/nonlinear model, wherein the coefficients of model terms are trained from neighboring luma and/or chroma samples.
      i. For example, the intra chroma fusion may be based on a single model.
      ii. For example, the intra chroma fusion may be based on multiple models wherein samples are separated into more than one category and each category has its own model.
   e. For example, training samples above the first row of the CTU top boundary may be allowed to be accessed.
      i. For example, M (e.g., M=6) rows of neighboring chroma samples and/or downsampled luma samples may be accessed for the model generation, if available, regardless of the CTU top boundary.
      ii. For example, 2*M (e.g., M=6) rows of neighboring non-downsampled luma samples may be accessed for the model generation, if available, regardless of the CTU top boundary.
      iii. Alternatively, for example, training samples above the first row of the CTU top boundary may NOT be allowed to be accessed.
         1. For example, in such case, only the first row of the CTU top boundary may be accessed for the model generation.
k. In one example, for a CCLM mode, samples above the first row of the CTU top boundary may be allowed to be accessed for model coefficients calculation.
   a. For example, luma samples above the first row of the CTU top boundary may be used to generate the downsampled luma values.
l. In one example, for an intra luma prediction mode, samples above the first row of the CTU top boundary may be allowed to be accessed.
   a. For example, samples above the first row of the CTU top boundary may be used as reference samples for an intra luma prediction mode.
      i. For example, it may be used for the intra mode using multiple reference lines (e.g., MRL, extended MRL, etc.).
      ii. For example, it may be used for the intra mode using template based multiple reference lines (e.g., TMRL).
   b. For example, whether a certain MRL index is valid or not may be jointly determined based on the location of the reference line and the location of current video unit and the max allowed number of reference rows above the CTU top boundary.
      i. For example, suppose h denotes the vertical coordinator of the current video unit relative the vertical coordinator of the current CTU, max denotes the max allowed number of reference rows above the CTU top boundary, length denotes the distance between the MRL/TMRL indexed reference line and the current video unit, tmpSize denotes the template size of TMRL mode,
         1. For example, when the current video unit doesn't belong to the first row of CTU of current picture, and if (h+max)<length, such MRL index may NOT be valid.
         a. Furthermore, for example, if (h+max)< (length-tmpSize), such TMRL index may NOT be valid.
         2. For example, when the current video unit belongs to the first row of CTU of current picture, and if h<length, such MRL index may NOT be valid.
         a. Furthermore, for example, if h< (length-tmpSize), such TMRL index may NOT be valid.

4.4 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

4.5 Whether to and/or how to apply the disclosed methods above may be signalled at PB/TB/CB/PU/TU/CU/VPDU/CTU/CTU row/slice/tile/sub-picture/other kinds of region contain more than one sample or pixel.

4.6 Whether to and/or how to apply the disclosed methods above may be dependent on coded information, such as block size, colour format, single/dual tree partitioning, colour component, slice/picture type.

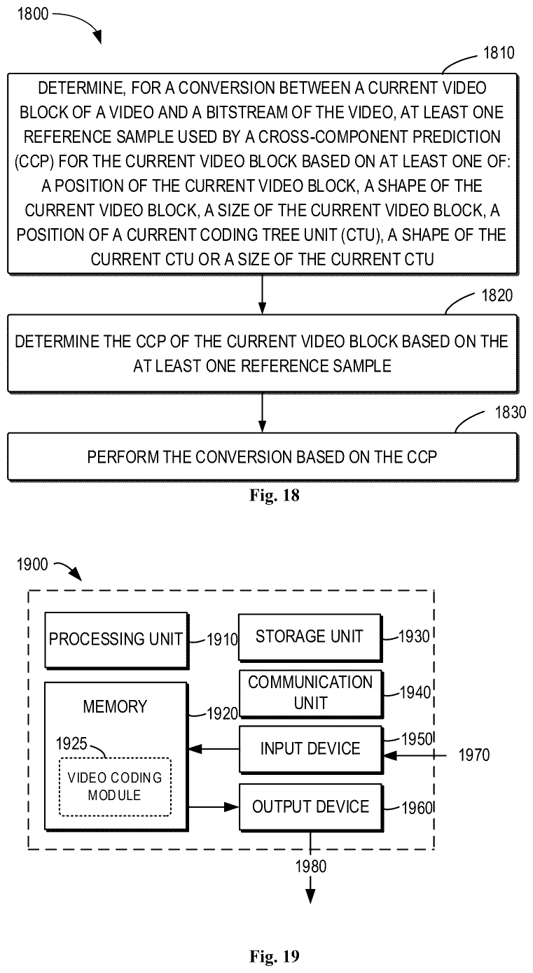

Further details will be described below. FIG. 18 illustrates a flowchart of a method 1800 for video processing in accordance with embodiments of the present disclosure. The method 1800 is for a conversion between a current video block of a video and a bitstream of the video.

At block 1810, at least one reference sample used by a cross-component prediction (CCP) for the current video block is determined based on at least one of: a position of the current video block, a shape of the current video block, a size of the current video block, a position of a current coding tree unit (CTU), a shape of the current CTU or a size of the current CTU.

At block 1820, the CCP of the current video block is determined based on the at least one reference sample.

At block 1830, the conversion is performed based on the CCP. In some embodiments, the conversion includes encoding the current video block into the bitstream. Alternatively, or in addition, in some embodiments, the conversion includes decoding the current video block from the bitstream.

The method 1800 enables selection of the reference sample based on the position and/or shape/size of the current block and/or the current CTU. The coding effectiveness and/or coding efficiency can thus be improved.

In some embodiments, the at least one reference sample comprises at least one of a luma sample or a chroma sample.

In some embodiments, the at least one reference sample is determined based on whether the current video block is on a boundary of a CTU.

In some embodiments, the at least one reference sample is determined based on whether the current video block is on a boundary of a CTU row.

In some embodiments, whether a reference sample used by the CCP is in a valid region or out of the valid region is based on a position of the reference sample.

In some embodiments, the position of the reference sample is (x, y), if y is less than or equal to (Y0-M), the reference sample is out of the valid region, (X0, Y0) being a top-left position of the current CTU, M being an integer.

In some embodiments, a restriction of a number of rows of reconstruction or prediction samples above a top boundary of a CTU or a virtual pipeline data unit (VPDU) that is allowed to be accessed is aligned for intra mode coding. In other words, the restriction of how many rows of reconstruction/prediction samples above the CTU (or, VPDU) top boundary are allowed to be accessed, may be aligned for intra mode coding.

In some embodiments, the number of rows of samples above the top boundary of the CTU or the VPDU is restricted to a same value for at least two of the following intra modes: a cross-component linear model (CCLM), a multi-model linear model (MMLM), a convolutional cross-component model (CCCM), a variant of the CCCM, a gradient linear model (GLM), a GLM with luma, a variant of the GLM, a template-based multiple reference line intra prediction (TMRL), a variant of the TMRL, a multiple reference line (MRL), a variant of the MRL, an intra chroma fusion, a chroma fusion with luma, a variant of the intra chroma fusion, a decoder side intra mode derivation (DIMD), a variant of the DIMD, a template-based intra mode derivation (TIMD), a variant of the TIMD, an intra template matching, a variant of the intra template matching, a spatial geometric partitioning mode (SGPM), a variant of the SGPM, a derived block vector (DBV) chroma, or a variant of the DBV chroma.

In some embodiments, the variant of the CCCM comprises at least one of: a gradient and location based CCCM (GL-CCCM), or a CCCM without down-sampling.

In some embodiments, a template of an intra mode comprises at least one sample above a first row of a top boundary of a CTU.

In some embodiments, the template is used for a template based intra mode coding.

In some embodiments, the template based intra mode comprises at least one of: a template based multiple reference line selection, a CCP mode, a decoder side intra mode derivation (DIMD) mode, a template-based intra mode derivation (TIMD) mode, a template cost based intra chroma fusion, an intra template matching prediction (intraTMP), a related mode of the intraTMP, or a derived block vector (DBV) mode.

In some embodiments, the template based multiple reference line selection comprises at least one of: a template-based multiple reference line intra prediction (TMRL), or an extended multiple reference line (MRL) list.

In some embodiments, the CCP mode comprises at least one of: a cross-component linear model (CCLM), a convolutional cross-component model (CCCM), a gradient linear model (GLM), a CCCM with down-sampling, a CCCM without down-sampling, a gradient and location based CCCM (GL-CCCM), a history-based CCP mode, a non-adjacent-based CCO mode, a non-local CCP mode, or a cross-component merge (CCMerge) mode.

In some embodiments, the DIMD mode comprises at least one of: a DIMD luma, a DIMD chroma, or a location dependent DIMD.

In some embodiments, a restriction of a number of rows of reconstruction or prediction samples above a top boundary of a CTU or a virtual pipeline data unit (VPDU) that is allowed to be accessed is aligned for inter mode coding. In other words, the restriction of how many rows of reconstruction/prediction samples above the CTU (or, VPDU) top boundary are allowed to be accessed, may be aligned for inter mode coding.

In some embodiments, the number of rows of samples above the top boundary of the CTU or the VPDU is restricted to a same value for at least two of the following inter modes: an inter template matching based mode, an inter template cost based mode, a geometric partitioning mode (GPM) inter-intra, a variant of the GPM inter-intra, an overlapped block motion compensation (OBMC), a variant of the OBMC, a local illumination compensation (LIC), a variant of the LIC, a multi-hypothesis prediction (MHP), or a variant of the MHP.

In some embodiments, the inter matching based mode comprises at least one of: a template matching (TM) merge, a GPM TM, a combined inter and intra prediction (CIIP) TM, a sub-temporal motion vector prediction (subTMVP) TM, a bi-prediction with coding unit (CU)-level weights (BCW) TM, an affine TM, a merge with motion vector prediction (MMVD) TM, or a TM refinement.

In some embodiments, the inter template cost-based mode comprises at least one of: an adaptive reordering-based motion compensation (ARMC), a block-based reference picture reordering, a GPM split mode reordering, a motion vector difference (MVD) sign prediction, or a merge list reordering.

In some embodiments, a template of an inter mode comprises at least one sample above a first row of the top boundary of the CTU.

In some embodiments, the template is used for a template based inter mode coding.

In some embodiments, the template based inter mode comprises at least one of: a template matching (TM) merge, a TM advanced motion vector prediction (AMVP), a template-based merge with motion vector difference (MMVD), a template-based combined inter and intra prediction (CIIP), a template-based geometric partitioning mode (GPM) prediction, a template-based Affine prediction, a template-based subblock temporal motion vector prediction (SbTMVP), a template-based AMVP prediction, a template-based reference picture reordering, a template-based motion vector difference (MVD) sign prediction, or a template-based MVD coefficient prediction.

In some embodiments, a restriction of a number of rows of reconstruction or prediction samples above a top boundary of a CTU or a virtual pipeline data unit (VPDU) that is allowed to be accessed is aligned for screen content coding (SCC) mode coding. In other words, the restriction of how many rows of reconstruction/prediction samples above the CTU (or, VPDU) top boundary are allowed to be accessed, may be aligned for SCC mode coding.

In some embodiments, the number of rows of samples above the top boundary of the CTU or the VPDU is restricted to a same value for at least two of the following SCC modes: a regular intra block copy (IBC), a reconstruction-reordered IBC (RR-IBC), a block vector difference (BVD) sign prediction, a template matching based block vector (BV) refinement, a template cost-based BV candidate reordering, a derived block vector (DBV) chroma, or a variant of the DBV chroma, an intra template matching, or a variant of the intra template matching.

In some embodiments, a template of the SCC mode comprises at least one sample above a first row of the top boundary of the CTU.

In some embodiments, the template is used for a template-based SCC mode coding.

In some embodiments, the template-based SCC mode comprises at least one of: an intra template matching prediction (intraTMP) mode, a mode related to the intraTMP, a derived block vector (DBV) mode, a template-based IBC prediction, a template-based RR-IBC prediction, a template-based BVD sign prediction, or a template-based merge with block vector difference (MBVD).

In some embodiments, a restriction of a number of rows of reconstruction or prediction samples above a top boundary of a CTU or a virtual pipeline data unit (VPDU) that is allowed to be accessed is aligned for intra mode coding, inter mode coding and screen content coding (SCC) mode coding. In other words, the restriction of how many rows of reconstruction/prediction samples above the CTU (or, VPDU) top boundary are allowed to be accessed, may be aligned for intra mode coding and inter mode coding and SCC mode coding.

In some embodiments, for a first prediction mode, a reference line is restricted to not exceed a first number of rows of samples above a top boundary of a CTU.

In some embodiments, for chroma samples, the first number comprises one of: 1, 6 or 12.

In some embodiments, for non-down-sampled luma samples, the first number comprises one of: 1, 6 or 12.

In some embodiments, for down-sampled luma samples, the first number comprises one of: 1, 6 or 12.

In some embodiments, if the reference line exceeds a k-th row of samples above the top boundary of the CTU, k being the first number, the first prediction mode is not allowed or used or enabled or applied to the current video block.

In some embodiments, if the reference line exceeds a k-th row of samples above the top boundary of the CTU, k being the first number, the reference line is not used for the current video block, and the first prediction mode is allowed or used or enabled or applied to the current video block.

In some embodiments, the first number of rows of reference samples are used.

In some embodiments, difference values of the first number are used for different modes.

In some embodiments, at least two prediction modes have a same restriction on a value of the first number.

In some embodiments, at least one reference sample out of a valid region is padded.

In some embodiments, at least one reference sample out of a valid region is not used to determine a CCP model.

In some embodiments, for luma value-based intra chroma fusion, a set of neighboring samples is used as training samples to modulate an intra chroma fusion model, the set of neighboring samples comprising at least one of: a first number of rows of neighboring samples, the first number being less than or equal to a first threshold, or a second number of columns of neighboring samples, the second number being less than or equal to a second threshold.

In some embodiments, the first threshold is 6, and the second threshold is 6.

In some embodiments, the neighboring samples comprises at least one of: neighboring chroma samples, or neighboring down-sampled luma samples.

In some embodiments, the first threshold is 12, and the second threshold is 12.

In some embodiments, the neighboring samples comprises at least one of: neighboring chroma samples, or neighboring non-down-sampled luma samples.

In some embodiments, the intra chroma fusion comprises a mode fusing a non-linear model (LM) chroma prediction with a collocated down-sampled luma reconstruction.

In some embodiments, the intra chroma fusion is based on a linear or non-linear model, coefficients of the model are trained from neighboring samples, the neighboring samples comprising at least one of: neighboring luma samples or neighboring chroma samples.

In some embodiments, the intra chroma fusion is based on a single model.

In some embodiments, the intra chroma fusion is based on a plurality of models, wherein samples are separated into a plurality of groups, each group corresponding to a model of the plurality of models.

In some embodiments, training samples above a first row of a top boundary of the CTU is allowed to be accessed.

In some embodiments, a first number of rows of neighboring samples is acceded for generating a model regardless of a top boundary of a CTU, the neighboring samples comprising neighboring chroma samples and/or down-sampled luma samples.

In some embodiments, the first number is 6.

In some embodiments, a first number of rows of neighboring samples is acceded for generating a model regardless of a top boundary of a CTU, the neighboring samples comprising neighboring chroma samples and/or non-down-sampled luma samples.

In some embodiments, the first number is 12.

In some embodiments, training samples above a first row of a top boundary of the CTU is not allowed to be accessed.

In some embodiments, the first row of the top boundary of the CTU is allowed to be accessed.

In some embodiments, for a cross-component linear model (CCLM) mode, samples above a first row of a top boundary of a CTU is allowed to be accessed for determining model coefficients.

In some embodiments, luma samples above the first row of the top boundary of the CTU is used to determine down-samples luma values.

In some embodiments, for an intra luma prediction mode, samples above a first row of a top boundary of a CTU is allowed to be accessed for determining model coefficients.

In some embodiments, samples above the first row of the top boundary of the CTU is used as reference samples for an intra luma prediction mode.

In some embodiments, the reference samples are used for an intra mode using multiple reference lines.

In some embodiments, the intra mode comprises at least one of: a multiple reference line (MRL), or an extended MRL.

In some embodiments, the reference samples are used for an intra mode using template-based multiple reference lines.

In some embodiments, the intra mode comprises a template-based multiple reference line intra prediction (TMRL).

In some embodiments, whether a multiple reference line (MRL) index is valid is jointly determined based on a location of a reference line, a location of the current video block, and a maximum allowed number of reference rows above a top boundary of a CTU.

In some embodiments, if the current video block does not belong to a first row of a current CTU of a current picture, and if (h+max)<length, the MRL index is not valid, where h denotes a vertical coordinator of the current video block relative a vertical coordinator of the current CTU, max denotes a maximum allowed number of reference rows above a top boundary of the current CTU, and length denotes a distance between the MRL or template-based multiple reference line intra prediction (TMRL) indexed reference line and the current video block.

In some embodiments, if the current video block does not belong to a first row of a current CTU of a current picture, and if (h+max)< (length-tmpSize), a template-based multiple reference line intra prediction (TMRL) index is not valid, where h denotes a vertical coordinator of the current video block relative a vertical coordinator of the current CTU, max denotes a maximum allowed number of reference rows above a top boundary of the current CTU, length denotes a distance between the MRL or TMRL indexed reference line and the current video block, and tmpSize denotes a template size of TMRL mode.

In some embodiments, if the current video block belongs to a first row of a current CTU of a current picture, and if h<length, the MRL index is not valid, where h denotes a vertical coordinator of the current video block relative a vertical coordinator of the current CTU, and length denotes a distance between the MRL or template-based multiple reference line intra prediction (TMRL) indexed reference line and the current video block.

In some embodiments, if the current video block belongs to a first row of a current CTU of a current picture, and if h< (length-tmpSize), a template-based multiple reference line intra prediction (TMRL) index is not valid, where h denotes a vertical coordinator of the current video block relative a vertical coordinator of the current CTU, length denotes a distance between the MRL or TMRL indexed reference line and the current video block, and tmpSize denotes a template size of TMRL mode.

In some embodiments, information regarding whether to and/or how to apply the method 1800 is indicated in the bitstream.

In some embodiments, the information is indicated at one of: a sequence level, a group of pictures level, a picture level, a slice level or a tile group level.

In some embodiments, the information is indicated in at least one of the following coding structures: a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the information is included in a region comprising more than one sample or pixel, the region comprising one of: a prediction block (PB), a transform block (TB), a coding block (CB), a prediction unit (PU), a transform unit (TU), a coding unit (CU), a virtual pipeline data unit (VPUD), a coding tree unit (CTU), a CTU row, a slice, a tile, or a sub-picture.

In some embodiments, the information is based on coded information.

In some embodiments, the coded information comprises at least one of: a block size, a color format, a single or dual tree partitioning, a color component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, at least one reference sample used by a cross-component prediction (CCP) for a current video block of the video is determined based on at least one of: a position of the current video block, a shape of the current video block, a size of the current video block, a position of a current coding tree unit (CTU), a shape of the current CTU or a size of the current CTU. The CCP of the current video block is determined based on the at least one reference sample. The bitstream is generated based on the CCP.

According to still further embodiments of the present disclosure, a method for storing bitstream of a video is provided. In the method, at least one reference sample used by a cross-component prediction (CCP) for a current video block of the video is determined based on at least one of: a position of the current video block, a shape of the current video block, a size of the current video block, a position of a current coding tree unit (CTU), a shape of the current CTU or a size of the current CTU. The CCP of the current video block is determined based on the at least one reference sample. The bitstream is generated based on the CCP. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, at least one reference sample used by a cross-component prediction (CCP) for the current video block based on at least one of: a position of the current video block, a shape of the current video block, a size of the current video block, a position of a current coding tree unit (CTU), a shape of the current CTU or a size of the current CTU; determining the CCP of the current video block based on the at least one reference sample; and performing the conversion based on the CCP.

Clause 2. The method of clause 1, wherein the at least one reference sample comprises at least one of a luma sample or a chroma sample.

Clause 3. The method of clause 1 or 2, wherein the at least one reference sample is determined based on whether the current video block is on a boundary of a CTU.

Clause 4. The method of clause 1 or 2, wherein the at least one reference sample is determined based on whether the current video block is on a boundary of a CTU row.

Clause 5. The method of any of clauses 1-4, wherein whether a reference sample used by the CCP is in a valid region or out of the valid region is based on a position of the reference sample.

Clause 6. The method of clause 5, wherein the position of the reference sample is (x, y), if y is less than or equal to (Y0-M), the reference sample is out of the valid region, (X0, Y0) being a top-left position of the current CTU, M being an integer.

Clause 7. The method of any of clauses 1-6, wherein a restriction of a number of rows of reconstruction or prediction samples above a top boundary of a CTU or a virtual pipeline data unit (VPDU) that is allowed to be accessed is aligned for intra mode coding.

Clause 8. The method of clause 7, wherein the number of rows of samples above the top boundary of the CTU or the VPDU is restricted to a same value for at least two of the following intra modes: a cross-component linear model (CCLM), a multi-model linear model (MMLM), a convolutional cross-component model (CCCM), a variant of the CCCM, a gradient linear model (GLM), a GLM with luma, a variant of the GLM, a template-based multiple reference line intra prediction (TMRL), a variant of the TMRL, a multiple reference line (MRL), a variant of the MRL, an intra chroma fusion, a chroma fusion with luma, a variant of the intra chroma fusion, a decoder side intra mode derivation (DIMD), a variant of the DIMD, a template-based intra mode derivation (TIMD), a variant of the TIMD, an intra template matching, a variant of the intra template matching, a spatial geometric partitioning mode (SGPM), a variant of the SGPM, a derived block vector (DBV) chroma, or a variant of the DBV chroma.

Clause 9. The method of clause 8, wherein the variant of the CCCM comprises at least one of: a gradient and location based CCCM (GL-CCCM), or a CCCM without down-sampling.

Clause 10. The method of any of clauses 7-9, wherein a template of an intra mode comprises at least one sample above a first row of a top boundary of a CTU.

Clause 11. The method of clause 10, wherein the template is used for a template based intra mode coding.

Clause 12. The method of clause 11, wherein the template based intra mode comprises at least one of: a template based multiple reference line selection, a CCP mode, a decoder side intra mode derivation (DIMD) mode, a template-based intra mode derivation (TIMD) mode, a template cost based intra chroma fusion, an intra template matching prediction (intraTMP), a related mode of the intraTMP, or a derived block vector (DBV) mode.

Clause 13. The method of clause 12, wherein the template based multiple reference line selection comprises at least one of: a template-based multiple reference line intra prediction (TMRL), or an extended multiple reference line (MRL) list.

Clause 14. The method of clause 12, wherein the CCP mode comprises at least one of: a cross-component linear model (CCLM), a convolutional cross-component model (CCCM), a gradient linear model (GLM), a CCCM with down-sampling, a CCCM without down-sampling, a gradient and location based CCCM (GL-CCCM), a history-based CCP mode, a non-adjacent-based CCO mode, a non-local CCP mode, or a cross-component merge (CCMerge) mode.

Clause 15. The method of clause 12, wherein the DIMD mode comprises at least one of: a DIMD luma, a DIMD chroma, or a location dependent DIMD.

Clause 16. The method of any of clauses 1-6, wherein a restriction of a number of rows of reconstruction or prediction samples above a top boundary of a CTU or a virtual pipeline data unit (VPDU) that is allowed to be accessed is aligned for inter mode coding.

Clause 17. The method of clause 16, wherein the number of rows of samples above the top boundary of the CTU or the VPDU is restricted to a same value for at least two of the following inter modes: an inter template matching based mode, an inter template cost based mode, a geometric partitioning mode (GPM) inter-intra, a variant of the GPM inter-intra, an overlapped block motion compensation (OBMC), a variant of the OBMC, a local illumination compensation (LIC), a variant of the LIC, a multi-hypothesis prediction (MHP), or a variant of the MHP.

Clause 18. The method of clause 17, wherein the inter matching based mode comprises at least one of: a template matching (TM) merge, a GPM TM, a combined inter and intra prediction (CIIP) TM, a sub-temporal motion vector prediction (subTMVP) TM, a bi-prediction with coding unit (CU)-level weights (BCW) TM, an affine TM, a merge with motion vector prediction (MMVD) TM, or a TM refinement.

Clause 19. The method of clause 17, wherein the inter template cost based mode comprises at least one of: an adaptive reordering-based motion compensation (ARMC), a block-based reference picture reordering, a GPM split mode reordering, a motion vector difference (MVD) sign prediction, or a merge list reordering.

Clause 20. The method of any of clauses 16-19, wherein a template of an inter mode comprises at least one sample above a first row of the top boundary of the CTU.

Clause 21. The method of clause 20, wherein the template is used for a template based inter mode coding.

Clause 22. The method of clause 21, wherein the template based inter mode comprises at least one of: a template matching (TM) merge, a TM advanced motion vector prediction (AMVP), a template-based merge with motion vector difference (MMVD), a template-based combined inter and intra prediction (CIIP), a template-based geometric partitioning mode (GPM) prediction, a template-based Affine prediction, a template-based subblock temporal motion vector prediction (SbTMVP), a template-based AMVP prediction, a template-based reference picture reordering, a template-based motion vector difference (MVD) sign prediction, or a template-based MVD coefficient prediction.

Clause 23. The method of any of clauses 1-6, wherein a restriction of a number of rows of reconstruction or prediction samples above a top boundary of a CTU or a virtual pipeline data unit (VPDU) that is allowed to be accessed is aligned for screen content coding (SCC) mode coding.

Clause 24. The method of clause 23, wherein the number of rows of samples above the top boundary of the CTU or the VPDU is restricted to a same value for at least two of the following SCC modes: a regular intra block copy (IBC), a reconstruction-reordered IBC (RR-IBC), a block vector difference (BVD) sign prediction, a template matching based block vector (BV) refinement, a template cost-based BV candidate reordering, a derived block vector (DBV) chroma, or a variant of the DBV chroma, an intra template matching, or a variant of the intra template matching.

Clause 25. The method of clause 23 or 24, wherein a template of the SCC mode comprises at least one sample above a first row of the top boundary of the CTU.

Clause 26. The method of clause 25, wherein the template is used for a template-based SCC mode coding.

Clause 27. The method of clause 26, wherein the template-based SCC mode comprises at least one of: an intra template matching prediction (intraTMP) mode, a mode related to the intraTMP, a derived block vector (DBV) mode, a template-based IBC prediction, a template-based RR-IBC prediction, a template-based BVD sign prediction, or a template-based merge with block vector difference (MBVD).

Clause 28. The method of any of clauses 1-6, wherein a restriction of a number of rows of reconstruction or prediction samples above a top boundary of a CTU or a virtual pipeline data unit (VPDU) that is allowed to be accessed is aligned for intra mode coding, inter mode coding and screen content coding (SCC) mode coding.

Clause 29. The method of any of clauses 1-28, wherein for a first prediction mode, a reference line is restricted to not exceed a first number of rows of samples above a top boundary of a CTU.

Clause 30. The method of clause 29, wherein for chroma samples, the first number comprises one of: 1, 6 or 12.

Clause 31. The method of clause 29, wherein for non-down-sampled luma samples, the first number comprises one of: 1, 6 or 12.

Clause 32. The method of clause 29, wherein for down-sampled luma samples, the first number comprises one of: 1, 6 or 12.

Clause 33. The method of any of clauses 29-32, wherein if the reference line exceeds a k-th row of samples above the top boundary of the CTU, k being the first number, the first prediction mode is not allowed or used or enabled or applied to the current video block.

Clause 34. The method of any of clauses 29-32, wherein if the reference line exceeds a k-th row of samples above the top boundary of the CTU, k being the first number, the reference line is not used for the current video block, and the first prediction mode is allowed or used or enabled or applied to the current video block.

Clause 35. The method of clause 34, wherein the first number of rows of reference samples are used.

Clause 36. The method of any of clauses 29-35, wherein difference values of the first number are used for different modes.

Clause 37. The method of any of clauses 29-35, wherein at least two prediction modes have a same restriction on a value of the first number.

Clause 38. The method of any of clauses 1-37, wherein at least one reference sample out of a valid region is padded.

Clause 39. The method of any of clauses 1-37, wherein at least one reference sample out of a valid region is not used to determine a CCP model.

Clause 40. The method of any of clauses 1-39, wherein for luma value-based intra chroma fusion, a set of neighboring samples is used as training samples to modulate an intra chroma fusion model, the set of neighboring samples comprising at least one of: a first number of rows of neighboring samples, the first number being less than or equal to a first threshold, or a second number of columns of neighboring samples, the second number being less than or equal to a second threshold.

Clause 41. The method of clause 40, wherein the first threshold is 6, and the second threshold is 6.

Clause 42. The method of clause 41, wherein the neighboring samples comprises at least one of: neighboring chroma samples, or neighboring down-sampled luma samples.

Clause 43. The method of clause 40, wherein the first threshold is 12, and the second threshold is 12.

Clause 44. The method of clause 43, wherein the neighboring samples comprises at least one of: neighboring chroma samples, or neighboring non-down-sampled luma samples.

Clause 45. The method of any of clauses 40-44, wherein the intra chroma fusion comprises a mode fusing a non-linear model (LM) chroma prediction with a collocated down-sampled luma reconstruction.

Clause 46. The method of any of clauses 40-45, wherein the intra chroma fusion is based on a linear or non-linear model, coefficients of the model are trained from neighboring samples, the neighboring samples comprising at least one of: neighboring luma samples or neighboring chroma samples.

Clause 47. The method of clause 46, wherein the intra chroma fusion is based on a single model.

Clause 48. The method of clause 46, wherein the intra chroma fusion is based on a plurality of models, wherein samples are separated into a plurality of groups, each group corresponding to a model of the plurality of models.

Clause 49. The method of any of clauses 40-48, wherein training samples above a first row of a top boundary of the CTU is allowed to be accessed.

Clause 50. The method of clause 49, wherein a first number of rows of neighboring samples is acceded for generating a model regardless of a top boundary of a CTU, the neighboring samples comprising neighboring chroma samples and/or down-sampled luma samples.

Clause 51. The method of clause 50, wherein the first number is 6.

Clause 52. The method of clause 49, wherein a first number of rows of neighboring samples is acceded for generating a model regardless of a top boundary of a CTU, the neighboring samples comprising neighboring chroma samples and/or non-down-sampled luma samples.

Clause 53. The method of clause 52, wherein the first number is 12.

Clause 54. The method of any of clauses 40-48, wherein training samples above a first row of a top boundary of the CTU is not allowed to be accessed.

Clause 55. The method of clause 54, wherein the first row of the top boundary of the CTU is allowed to be accessed.

Clause 56. The method of any of clauses 1-55, wherein for a cross-component linear model (CCLM) mode, samples above a first row of a top boundary of a CTU is allowed to be accessed for determining model coefficients.

Clause 57. The method of clause 56, wherein luma samples above the first row of the top boundary of the CTU is used to determine down-samples luma values.

Clause 58. The method of any of clauses 1-57, wherein for an intra luma prediction mode, samples above a first row of a top boundary of a CTU is allowed to be accessed for determining model coefficients.

Clause 59. The method of clause 58, wherein samples above the first row of the top boundary of the CTU is used as reference samples for an intra luma prediction mode.

Clause 60. The method of clause 59, wherein the reference samples are used for an intra mode using multiple reference lines.

Clause 61. The method of clause 60, wherein the intra mode comprises at least one of: a multiple reference line (MRL), or an extended MRL.

Clause 62. The method of clause 59, wherein the reference samples are used for an intra mode using template-based multiple reference lines.

Clause 63. The method of clause 62, wherein the intra mode comprises a template-based multiple reference line intra prediction (TMRL).

Clause 64. The method of any of clauses 58-63, wherein whether a multiple reference line (MRL) index is valid is jointly determined based on a location of a reference line, a location of the current video block, and a maximum allowed number of reference rows above a top boundary of a CTU.

Clause 65. The method of clause 64, wherein if the current video block does not belong to a first row of a current CTU of a current picture, and if (h+max)<length, the MRL index is not valid, where h denotes a vertical coordinator of the current video block relative a vertical coordinator of the current CTU, max denotes a maximum allowed number of reference rows above a top boundary of the current CTU, and length denotes a distance between the MRL or template-based multiple reference line intra prediction (TMRL) indexed reference line and the current video block.

Clause 66. The method of clause 64, wherein if the current video block does not belong to a first row of a current CTU of a current picture, and if (h+max)< (length-tmpSize), a template-based multiple reference line intra prediction (TMRL) index is not valid, where h denotes a vertical coordinator of the current video block relative a vertical coordinator of the current CTU, max denotes a maximum allowed number of reference rows above a top boundary of the current CTU, length denotes a distance between the MRL or TMRL indexed reference line and the current video block, and tmpSize denotes a template size of TMRL mode.

Clause 67. The method of clause 64, wherein if the current video block belongs to a first row of a current CTU of a current picture, and if h<length, the MRL index is not valid, where h denotes a vertical coordinator of the current video block relative a vertical coordinator of the current CTU, and length denotes a distance between the MRL or template-based multiple reference line intra prediction (TMRL) indexed reference line and the current video block.

Clause 68. The method of clause 64, wherein if the current video block belongs to a first row of a current CTU of a current picture, and if h< (length-tmpSize), a template-based multiple reference line intra prediction (TMRL) index is not valid, where h denotes a vertical coordinator of the current video block relative a vertical coordinator of the current CTU, length denotes a distance between the MRL or TMRL indexed reference line and the current video block, and tmpSize denotes a template size of TMRL mode.

Clause 69. The method of any of clauses 1-68, wherein information regarding whether to and/or how to apply the method is indicated in the bitstream.

Clause 70. The method of clause 69, wherein the information is indicated at one of: a sequence level, a group of pictures level, a picture level, a slice level or a tile group level.

Clause 71. The method of clause 69 or 70, wherein the information is indicated in at least one of the following coding structures: a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 72. The method of clause 69 or 70, wherein the information is included in a region comprising more than one sample or pixel, the region comprising one of: a prediction block (PB), a transform block (TB), a coding block (CB), a prediction unit (PU), a transform unit (TU), a coding unit (CU), a virtual pipeline data unit (VPUD), a coding tree unit (CTU), a CTU row, a slice, a tile, or a sub-picture.

Clause 73. The method of any of clauses 69-72, wherein the information is based on coded information.

Clause 74. The method of clause 73, wherein the coded information comprises at least one of: a block size, a color format, a single or dual tree partitioning, a color component, a slice type, or a picture type.

Clause 75. The method of any of clauses 1-74, wherein the conversion comprises encoding the current video block into the bitstream.

Clause 76. The method of any of clauses 1-74, wherein the conversion comprises decoding the current video block from the bitstream.

Clause 77. An apparatus for video processing comprising a processor and a non-transitory memory with instructions thereon, wherein the instructions upon execution by the processor, cause the processor to perform a method in accordance with any of clauses 1-76.

Clause 78. A non-transitory computer-readable storage medium storing instructions that cause a processor to perform a method in accordance with any of clauses 1-76.

Clause 79. A non-transitory computer-readable recording medium storing a bitstream of a video which is generated by a method performed by an apparatus for video processing, wherein the method comprises: determining at least one reference sample used by a cross-component prediction (CCP) for a current video block of the video based on at least one of: a position of the current video block, a shape of the current video block, a size of the current video block, a position of a current coding tree unit (CTU), a shape of the current CTU or a size of the current CTU; determining the CCP of the current video block based on the at least one reference sample; and generating the bitstream based on the CCP.

Clause 80. A method for storing a bitstream of a video, comprising: determining at least one reference sample used by a cross-component prediction (CCP) for a current video block of the video based on at least one of: a position of the current video block, a shape of the current video block, a size of the current video block, a position of a current coding tree unit (CTU), a shape of the current CTU or a size of the current CTU; determining the CCP of the current video block based on the at least one reference sample; generating the bitstream based on the CCP; and storing the bitstream in a non-transitory computer-readable recording medium.

### Example Device

FIG. 19 illustrates a block diagram of a computing device 1900 in which various embodiments of the present disclosure can be implemented. The computing device 1900 may be implemented as or included in the source device 110 (or the video encoder 114 or 200) or the destination device 120 (or the video decoder 124 or 300).

It would be appreciated that the computing device 1900 shown in FIG. 19 is merely for purpose of illustration, without suggesting any limitation to the functions and scopes of the embodiments of the present disclosure in any manner.

As shown in FIG. 19, the computing device 1900 includes a general-purpose computing device 1900. The computing device 1900 may at least comprise one or more processors or processing units 1910, a memory 1920, a storage unit 1930, one or more communication units 1940, one or more input devices 1950, and one or more output devices 1960.

In some embodiments, the computing device 1900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1900 can support any type of interface to a user (such as “wearable” circuitry and the like).

The processing unit 1910 may be a physical or virtual processor and can implement various processes based on programs stored in the memory 1920. In a multi-processor system, multiple processing units execute computer executable instructions in parallel so as to improve the parallel processing capability of the computing device 1900. The processing unit 1910 may also be referred to as a central processing unit (CPU), a microprocessor, a controller or a microcontroller.

The computing device 1900 typically includes various computer storage medium. Such medium can be any medium accessible by the computing device 1900, including, but not limited to, volatile and non-volatile medium, or detachable and non-detachable medium. The memory 1920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1930 may be any detachable or non-detachable medium and may include a machine-readable medium such as a memory, flash memory drive, magnetic disk or another other media, which can be used for storing information and/or data and can be accessed in the computing device 1900.

The computing device 1900 may further include additional detachable/non-detachable, volatile/non-volatile memory medium. Although not shown in FIG. 19, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1940 communicates with a further computing device via the communication medium. In addition, the functions of the components in the computing device 1900 can be implemented by a single computing cluster or multiple computing machines that can communicate via communication connections. Therefore, the computing device 1900 can operate in a networked environment using a logical connection with one or more other servers, networked personal computers (PCs) or further general network nodes.

The input device 1950 may be one or more of a variety of input devices, such as a mouse, keyboard, tracking ball, voice-input device, and the like. The output device 1960 may be one or more of a variety of output devices, such as a display, loudspeaker, printer, and the like. By means of the communication unit 1940, the computing device 1900 can further communicate with one or more external devices (not shown) such as the storage devices and display device, with one or more devices enabling the user to interact with the computing device 1900, or any devices (such as a network card, a modem and the like) enabling the computing device 1900 to communicate with one or more other computing devices, if required. Such communication can be performed via input/output (I/O) interfaces (not shown).

In some embodiments, instead of being integrated in a single device, some or all components of the computing device 1900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1900 may be used to implement video encoding/decoding in embodiments of the present disclosure. The memory 1920 may include one or more video coding modules 1925 having one or more program instructions. These modules are accessible and executable by the processing unit 1910 to perform the functionalities of the various embodiments described herein.

In the example embodiments of performing video encoding, the input device 1950 may receive video data as an input 1970 to be encoded. The video data may be processed, for example, by the video coding module 1925, to generate an encoded bitstream. The encoded bitstream may be provided via the output device 1960 as an output 1980.

In the example embodiments of performing video decoding, the input device 1950 may receive an encoded bitstream as the input 1970. The encoded bitstream may be processed, for example, by the video coding module 1925, to generate decoded video data. The decoded video data may be provided via the output device 1960 as the output 1980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, at least one reference sample used by a cross-component prediction (CCP) for the current video block based on at least one of: a position of the current video block, a shape of the current video block, a size of the current video block, a position of a current coding tree unit (CTU), a shape of the current CTU or a size of the current CTU;
determining the CCP of the current video block based on the at least one reference sample; and
performing the conversion based on the CCP.

2. The method of claim 1, wherein the at least one reference sample comprises at least one of a luma sample or a chroma sample,
wherein the at least one reference sample is determined based on whether the current video block is on a boundary of a CTU, or
wherein the at least one reference sample is determined based on whether the current video block is on a boundary of a CTU row.

3. The method of claim 1, wherein whether a reference sample used by the CCP is in a valid region or out of the valid region is based on a position of the reference sample,
wherein the position of the reference sample is (x, y), if y is less than or equal to (Y0-M), the reference sample is out of the valid region, (X0, Y0) being a top-left position of the current CTU, M being an integer.

4. The method of claim 1, wherein a restriction of a number of rows of reconstruction or prediction samples above a top boundary of a CTU or a virtual pipeline data unit (VPDU) that is allowed to be accessed is aligned for intra mode coding,
wherein the number of rows of samples above the top boundary of the CTU or the VPDU is restricted to a same value for at least two of the following intra modes:
a cross-component linear model (CCLM),
a multi-model linear model (MMLM),
a convolutional cross-component model (CCCM),
a variant of the CCCM, wherein the variant of the CCCM comprises at least one of: a gradient and location based CCCM (GL-CCCM), or a CCCM without down-sampling,
a gradient linear model (GLM),
a GLM with luma,
a variant of the GLM,
a template-based multiple reference line intra prediction (TMRL),
a variant of the TMRL,
a multiple reference line (MRL),
a variant of the MRL,
an intra chroma fusion,
a chroma fusion with luma,
a variant of the intra chroma fusion,
a decoder side intra mode derivation (DIMD),
a variant of the DIMD,
a template-based intra mode derivation (TIMD),
a variant of the TIMD,
an intra template matching,
a variant of the intra template matching,
a spatial geometric partitioning mode (SGPM),
a variant of the SGPM,
a derived block vector (DBV) chroma, or
a variant of the DBV chroma.

5. The method of claim 4, wherein a template of an intra mode comprises at least one sample above a first row of a top boundary of a CTU,
wherein the template is used for a template based intra mode coding,
wherein the template based intra mode comprises at least one of:
a template based multiple reference line selection, wherein the template based multiple reference line selection comprises at least one of: a template-based multiple reference line intra prediction (TMRL), or an extended multiple reference line (MRL) list,
a CCP mode, wherein the CCP mode comprises at least one of: a cross-component linear model (CCLM), a convolutional cross-component model (CCCM), a gradient linear model (GLM), a CCCM with down-sampling, a CCCM without down-sampling, a gradient and location based CCCM (GL-CCCM), a history-based CCP mode, a non-adjacent-based CCO mode, a non-local CCP mode, or a cross-component merge (CCMerge) mode,
a decoder side intra mode derivation (DIMD) mode, wherein the DIMD mode comprises at least one of: a DIMD luma, a DIMD chroma, or a location dependent DIMD,
a template-based intra mode derivation (TIMD) mode,
a template cost based intra chroma fusion,
an intra template matching prediction (intraTMP),
a related mode of the intraTMP, or
a derived block vector (DBV) mode.

6. The method of claim 1, wherein a restriction of a number of rows of reconstruction or prediction samples above a top boundary of a CTU or a virtual pipeline data unit (VPDU) that is allowed to be accessed is aligned for inter mode coding,
wherein the number of rows of samples above the top boundary of the CTU or the VPDU is restricted to a same value for at least two of the following inter modes:
an inter template matching based mode, wherein the inter template matching based mode comprises at least one of: a template matching (TM) merge, a GPM TM, a combined inter and intra prediction (CIIP) TM, a sub-temporal motion vector prediction (subTMVP) TM, a bi-prediction with coding unit (CU)-level weights (BCW) TM, an affine TM, a merge with motion vector prediction (MMVD) TM, or a TM refinement, an inter template cost based mode, wherein the inter template cost based mode comprises at least one of:
an adaptive reordering-based motion compensation (ARMC), a block-based reference picture reordering, a GPM split mode reordering, a motion vector difference (MVD) sign prediction, or a merge list reordering,
a geometric partitioning mode (GPM) inter-intra,
a variant of the GPM inter-intra,
an overlapped block motion compensation (OBMC),
a variant of the OBMC,
a local illumination compensation (LIC),
a variant of the LIC,
a multi-hypothesis prediction (MHP), or
a variant of the MHP.

7. The method of claim 6, wherein a template of an inter mode comprises at least one sample above a first row of the top boundary of the CTU,
wherein the template is used for a template based inter mode coding, and/or
wherein the template based inter mode comprises at least one of:
a template matching (TM) merge,
a TM advanced motion vector prediction (AMVP),
a template-based merge with motion vector difference (MMVD),
a template-based combined inter and intra prediction (CIIP),
a template-based geometric partitioning mode (GPM) prediction,
a template-based Affine prediction,
a template-based subblock temporal motion vector prediction (SbTMVP),
a template-based AMVP prediction,
a template-based reference picture reordering,
a template-based motion vector difference (MVD) sign prediction, or
a template-based MVD coefficient prediction.

8. The method of claim 1, wherein a restriction of a number of rows of reconstruction or prediction samples above a top boundary of a CTU or a virtual pipeline data unit (VPDU) that is allowed to be accessed is aligned for screen content coding (SCC) mode coding,
wherein the number of rows of samples above the top boundary of the CTU or the VPDU is restricted to a same value for at least two of the following SCC modes:
a regular intra block copy (IBC),
a reconstruction-reordered IBC (RR-IBC),
a block vector difference (BVD) sign prediction,
a template matching based block vector (BV) refinement,
a template cost-based BV candidate reordering,
a derived block vector (DBV) chroma,
or a variant of the DBV chroma,
an intra template matching, or
a variant of the intra template matching, and/or
wherein a template of the SCC mode comprises at least one sample above a first row of the top boundary of the CTU, wherein the template is used for a template-based SCC mode coding, wherein the template-based SCC mode comprises at least one of: an intra template matching prediction (intraTMP) mode, a mode related to the intraTMP, a derived block vector (DBV) mode, a template-based IBC prediction, a template-based RR-IBC prediction, a template-based BVD sign prediction, or a template-based merge with block vector difference (MBVD).

9. The method of claim 1, wherein a restriction of a number of rows of reconstruction or prediction samples above a top boundary of a CTU or a virtual pipeline data unit (VPDU) that is allowed to be accessed is aligned for intra mode coding, inter mode coding and screen content coding (SCC) mode coding, and/or
wherein at least one reference sample out of a valid region is padded, or wherein at least one reference sample out of a valid region is not used to determine a CCP model.

10. The method of claim 1, wherein for a first prediction mode, a reference line is restricted to not exceed a first number of rows of samples above a top boundary of a CTU,
wherein for chroma samples, the first number comprises one of: 1, 6 or 12, and/or
wherein for non-down-sampled luma samples, the first number comprises one of: 1, 6 or 12, and/or
wherein for down-sampled luma samples, the first number comprises one of: 1, 6 or 12,
wherein if the reference line exceeds a k-th row of samples above the top boundary of the CTU, k being the first number, the first prediction mode is not allowed or used or enabled or applied to the current video block, or
wherein if the reference line exceeds a k-th row of samples above the top boundary of the CTU, k being the first number, the reference line is not used for the current video block, and the first prediction mode is allowed or used or enabled or applied to the current video block, wherein the first number of rows of reference samples are used, and/or
wherein difference values of the first number are used for different modes, or wherein at least two prediction modes have a same restriction on a value of the first number.

11. The method of claim 1, wherein for luma value-based intra chroma fusion, a set of neighboring samples is used as training samples to modulate an intra chroma fusion model, the set of neighboring samples comprising at least one of:
a first number of rows of neighboring samples, the first number being less than or equal to a first threshold, or
a second number of columns of neighboring samples, the second number being less than or equal to a second threshold,
wherein the first threshold is 6, and the second threshold is 6, wherein the neighboring samples comprises at least one of: neighboring chroma samples, or neighboring down-sampled luma samples, or
wherein the first threshold is 12, and the second threshold is 12, wherein the neighboring samples comprises at least one of: neighboring chroma samples, or neighboring non-down-sampled luma samples,
wherein the intra chroma fusion comprises a mode fusing a non-linear model (LM) chroma prediction with a collocated down-sampled luma reconstruction, and/or
wherein the intra chroma fusion is based on a linear or non-linear model, coefficients of the model are trained from neighboring samples, the neighboring samples comprising at least one of: neighboring luma samples or neighboring chroma samples, or
wherein the intra chroma fusion is based on a single model, or wherein the intra chroma fusion is based on a plurality of models, wherein samples are separated into a plurality of groups, each group corresponding to a model of the plurality of models.

12. The method of claim 11, wherein training samples above a first row of a top boundary of the CTU is allowed to be accessed,
wherein a first number of rows of neighboring samples is acceded for generating a model regardless of a top boundary of a CTU, the neighboring samples comprising neighboring chroma samples and/or down-sampled luma samples, wherein the first number is 6, or
wherein a second number of rows of neighboring samples is acceded for generating a model regardless of a top boundary of a CTU, the neighboring samples comprising neighboring chroma samples and/or non-down-sampled luma samples, wherein the second number is 12.

13. The method of claim 11, wherein training samples above a first row of a top boundary of the CTU is not allowed to be accessed,
wherein the first row of the top boundary of the CTU is allowed to be accessed.

14. The method of claim 1, wherein for a cross-component linear model (CCLM) mode, samples above a first row of a top boundary of a CTU is allowed to be accessed for determining model coefficients,
wherein luma samples above the first row of the top boundary of the CTU is used to determine down-samples luma values.

15. The method of claim 1, wherein for an intra luma prediction mode, samples above a first row of a top boundary of a CTU are allowed to be accessed for determining model coefficients,
wherein samples above the first row of the top boundary of the CTU are used as reference samples for an intra luma prediction mode,
wherein the reference samples are used for an intra mode using multiple reference lines, wherein the intra mode comprises at least one of: a multiple reference line (MRL), or an extended MRL, or
wherein the reference samples are used for an intra mode using template-based multiple reference lines, wherein the intra mode comprises a template-based multiple reference line intra prediction (TMRL).

16. The method of claim 15, wherein whether a multiple reference line (MRL) index is valid is jointly determined based on a location of a reference line, a location of the current video block, and a maximum allowed number of reference rows above a top boundary of a CTU,
wherein if the current video block does not belong to a first row of a current CTU of a current picture, and if (h+max)<length, the MRL index is not valid, where h denotes a vertical coordinator of the current video block relative a vertical coordinator of the current CTU, max denotes a maximum allowed number of reference rows above a top boundary of the current CTU, and length denotes a distance between the MRL or template-based multiple reference line intra prediction (TMRL) indexed reference line and the current video block, or
wherein if the current video block does not belong to a first row of a current CTU of a current picture, and if (h+max)< (length-tmpSize), a template-based multiple reference line intra prediction (TMRL) index is not valid, where h denotes a vertical coordinator of the current video block relative a vertical coordinator of the current CTU, max denotes a maximum allowed number of reference rows above a top boundary of the current CTU, length denotes a distance between the MRL or TMRL indexed reference line and the current video block, and tmpSize denotes a template size of TMRL mode, or
wherein if the current video block belongs to a first row of a current CTU of a current picture, and if h <length, the MRL index is not valid, where h denotes a vertical coordinator of the current video block relative a vertical coordinator of the current CTU, and length denotes a distance between the MRL or template-based multiple reference line intra prediction (TMRL) indexed reference line and the current video block, or
wherein if the current video block belongs to a first row of a current CTU of a current picture, and if h <(length-tmpSize), a template-based multiple reference line intra prediction (TMRL) index is not valid, where h denotes a vertical coordinator of the current video block relative a vertical coordinator of the current CTU, length denotes a distance between the MRL or TMRL indexed reference line and the current video block, and tmpSize denotes a template size of TMRL mode.

17. The method of claim 1, wherein the conversion comprises encoding the current video block into the bitstream, or wherein the conversion comprises decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, at least one reference sample used by a cross-component prediction (CCP) for the current video block based on at least one of: a position of the current video block, a shape of the current video block, a size of the current video block, a position of a current coding tree unit (CTU), a shape of the current CTU or a size of the current CTU;
determine the CCP of the current video block based on the at least one reference sample; and
perform the conversion based on the CCP.

19. A non-transitory computer-readable storage medium storing instructions that cause a processor to perform acts comprising:
determining, for a conversion between a current video block of a video and a bitstream of the video, at least one reference sample used by a cross-component prediction (CCP) for the current video block based on at least one of: a position of the current video block, a shape of the current video block, a size of the current video block, a position of a current coding tree unit (CTU), a shape of the current CTU or a size of the current CTU;
determining the CCP of the current video block based on the at least one reference sample; and
performing the conversion based on the CCP.

20. A non-transitory computer-readable recording medium storing a bitstream of a video which is generated by a method performed by an apparatus for video processing, wherein the method comprises:
determining at least one reference sample used by a cross-component prediction (CCP) for a current video block of the video based on at least one of: a position of the current video block, a shape of the current video block, a size of the current video block, a position of a current coding tree unit (CTU), a shape of the current CTU or a size of the current CTU;
determining the CCP of the current video block based on the at least one reference sample; and
generating the bitstream based on the CCP.
